(19) United States
(12) Patent Application Publication
(10) Pub. No.: US 2021/0169266 A1
(43) Pub. Date: Jun. 10, 2021

(54) AUTOMATIC BREWING SYSTEM

(71) Applicant: BUNN-O-MATIC CORPORATION, Springfield, IL (US)

(72) Inventors: Emmanuel GUERIN, Springfield, IL (US); Nicolas TROCHERIS, Springfield, IL (US); Thierry GROULT, Springfield, IL (US)

(21) Appl. No.: 17/052,337

(22) PCT Filed: Apr. 30, 2019
(86) PCT No.: PCT/US2019/029797

§ 371 Date: Nov. 2, 2020

Related U.S. Application Data
(60) Provisional application No. 62/665,761, filed on May 2, 2018.

(51) Int. Cl. A47J 31/60; A47J 31/46

(52) U.S. Cl. CPC A47J 31/605; A47J 31/40; A47J 31/46

(57) ABSTRACT

An automatic brewing system includes a brewer, a brewing-substance delivery system coupled to the brewer, and a water-delivery system coupled to the brewer. The brewer, brewing-substance delivery system and water-delivery system are stored in a housing. The brewing-substance delivery system delivers brewing substance into the brewer for combination with water supplied by the water-delivery system to form a brewed beverage.

### PRIORITY CLAIM

This application claims priority under 35 U.S.C. § 119(e) to U.S. Provisional Application Ser. No. 62/665,761, filed May 2, 2018, the disclosure of which is expressly incorporated by reference herein in its entirety.

### BACKGROUND

The present disclosure relates to beverage brewers, and particularly to automated beverage brewers. More particularly, the present disclosure relates to an automated beverage brewing system for forming a brewed beverage from a brewing substance at the selection of a user.

### SUMMARY

According to the present disclosure, an automatic brewing system includes a brewer, a brewing-substance delivery system coupled to the brewer, and a water-delivery system coupled to the brewer. The brewer, brewing-substance delivery system and water-delivery system are stored in a housing. The brewing-substance delivery system delivers brewing substance into the brewer for combination with water supplied by the water-delivery system to form a brewed beverage.

In illustrative embodiments, the brewer includes a brew chamber, a filter, an upper piston, and a lower piston. Brewing substance is delivered into the brew chamber through a delivery window, and the upper piston closes the delivery window to block moisture from entering the brewing-substance delivery system during a brew cycle of the automatic brewing system. The lower piston is received in the filter and movable between a closed position blocking liquid from passing through the filter and an open position to allow liquid to pass through the filter. At least a portion of the filter is sloped to allow washing of used brewing substance off of the filter.

In illustrative embodiments, the brewing-substance delivery system includes hoppers, a dosing mechanism, and a delivery chute. The hoppers store various types of brewing substances used for brewing various beverages at the selection of a user. The dosing mechanism is adjustable to deliver brewing substance from the hopper containing the brewing substance used for the selected brew cycle through the delivery chute into the brew chamber. The dosing mechanism includes an index plate and a feed plate coupled to the index plate for movement therewith. The index plate rotates to position the feed plate relative to a selected hopper, and the feed plate passes brewing substance from the hoppers into the delivery chute.

### BRIEF DESCRIPTION OF THE DRAWINGS

The present disclosure will be described hereafter with reference to the attached drawings which are given as a non-limiting example only, in which:

FIG. 1 is a front perspective view of an automatic brewing system in accordance with the present disclosure showing that the automatic brewing system includes a brewer, a brewing-substance delivery system for delivering brewing substance into the brewer, and a water-delivery system for supplying water into the brewer to mix with the brewing substance to forma brewed beverage an suggesting that the components of the automatic brewing system are received in a housing;

FIG. 2 is a rear perspective view of the automatic brewing system of FIG. 1 showing that the water-delivery system includes a water tank, pumps, and heaters;

FIG. 3 is an upper perspective view of the brewing-substance delivery system of FIG. 1 showing that the brewing-substance delivery system includes hoppers for storing brewing substance, a dosing mechanism, and a delivery chute, and suggesting that the dosing mechanism transfers brewing substance from a selected hopper into the delivery chute to deliver the brewing substance into the brewer;

FIG. 4 is a side elevation view of the brewing-substance delivery system of FIG. 3;

FIG. 5 is a side elevation view of the brewer of FIG. 1 showing that the brewer includes a brew chamber, a filter movable relative to a lower end of the brew chamber, an upper piston movable relative to an upper portion of the brew chamber, and a lower piston movable relative to the filter;

FIG. 6 is a perspective view of the brewer of FIG. 5 showing that the filter includes a side wall, a slanted filter screen coupled to the side wall to define an interior region of the filter, and a plug coupled to the filter screen, and suggesting that the lower piston is received in the interior region of the filter;

FIG. 7 is a perspective view of the lower piston of FIG. 6;

FIG. 8 is a sectional view taken along line 8-8 in FIG. 6; and

FIGS. 9-14 are a series of views illustrating a brew cycle of the automatic brewing system in accordance with the present disclosure.

The exemplification set out herein illustrates embodiments of the disclosure that are not to be construed as limiting the scope of the disclosure in any manner Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure. The disclosure is not limited in its application to the details of structure, function, construction, or the arrangement of components set forth in the following description or illustrated in the drawings. The disclosure is capable of other embodiments and of being practiced or of being carried out in various ways. In addition, it is to be understood that the phraseology and terminology used herein is for the purpose of description and should not be regarded as limiting. The use of various phrases and terms is meant to encompass the items or functions identified and equivalents thereof as well as additional items or functions. Unless limited otherwise, various phrases, terms, and variations thereof herein are used broadly and encompass all variations of such phrases and terms. Furthermore, and as described in subsequent paragraphs, the specific configurations illustrated in the drawings are intended to exemplify embodiments of the disclosure. However, other alternative structures, functions, and configurations are possible which are considered to be within the teachings of the present disclosure. Furthermore, unless otherwise indicated, the term “or” is to be considered inclusive.

Terms including beverage, brewed, brewing, brewing substance, brewed liquid, and brewed beverage as may be used herein are intended to be broadly defined as including, but not limited to, the brewing of coffee, tea and any other beverages. This broad interpretation is also intended to include, but is not limited to any process of dispensing, infusing, steeping, reconstituting, diluting, dissolving, saturating or passing a liquid through or otherwise mixing or combining a brewing substance with a liquid such as water without limitation to the temperature of such liquid unless specified. This broad interpretation is also intended to include, but is not limited to, brewing substances such as ground coffee, tea, liquid beverage concentrate, powdered beverage concentrate, flaked, granular, freeze dried or other forms of materials including liquid, gel, crystal or other forms of beverage or food materials to obtain a desired beverage or other food product. Beverage brewing substances will be described in the present application and generally will be referred to as “coffee”. However, it should be understood that the term brewing substance should be broadly interpreted regardless of reference to brewing substance or coffee.

The foregoing terms as well as other terms should be broadly interpreted throughout this application to include all known as well as all hereafter discovered versions, equivalents, variations and other forms of the abovementioned terms as well as other terms. The present disclosure is intended to be broadly interpreted and not limited.

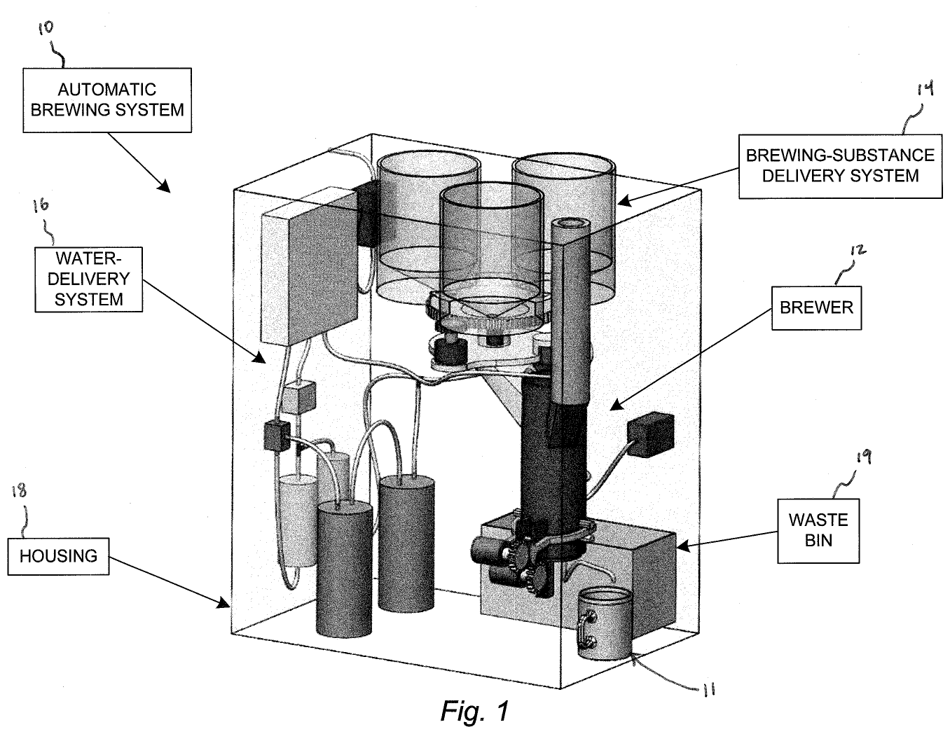

One embodiment of an automatic brewing system 10 in accordance with the present disclosure is shown in FIG. 1. Automatic brewing system 10 includes a brewer 12, a brewing-substance delivery system 14, and a water-delivery system 16. In the illustrative embodiment, the components of automatic brewing system 10 are stored in a housing 18. A brewing substance is delivered into brewer 12 from brewing-substance delivery system 14 for mixing with water from water-delivery system 16 to form a brewed beverage as part of a brew cycle of automatic brewing system 10. The brewed beverage is delivered into a container 11 of a user of automatic brewing system 10, and used brewing substance is collected in a waste bin 19 to reset automatic brewing system 10 for a subsequent brew cycle.

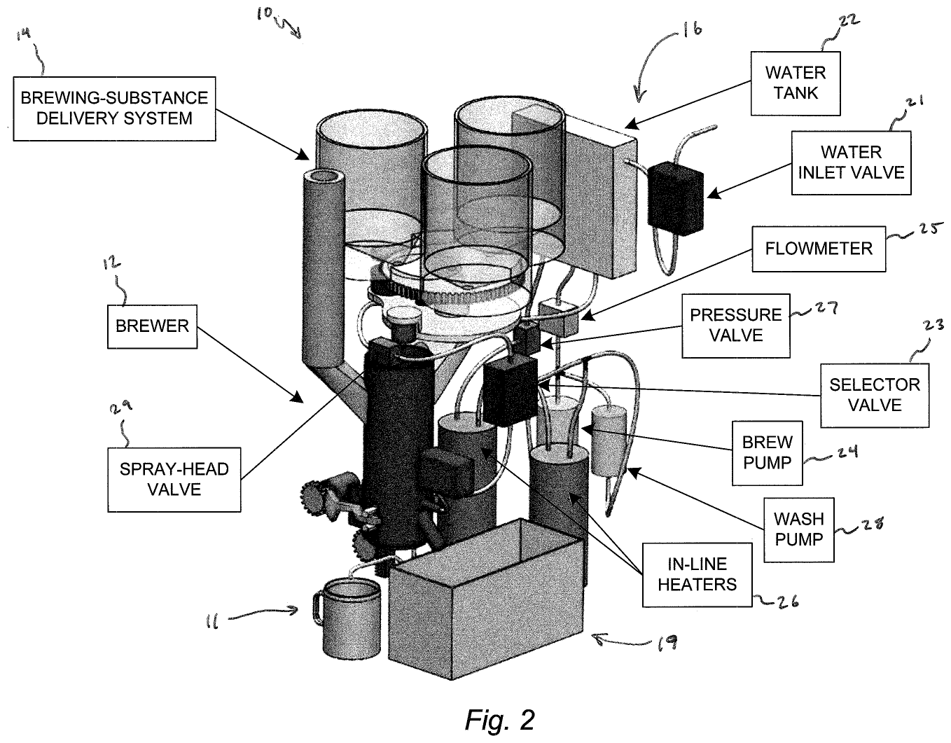

Water-delivery system 16 includes a water tank 22, a brew pump 24, in-line heaters 26, and a wash pump 28 as shown in FIG. 2. Water is selectively supplied to tank 22 through an inlet valve 21 according to readings from high and low level sensors coupled to tank 22. Brew pump 24 forces water from tank 22 through in-line heaters 26 to heat the water and deliver the heated water to brewer 12 to mix with the brewing substance and form the brewed beverage. A selector valve 23 selectively directs water to various portions of brewer 12 for forming the brewed beverage and for clearing used brewing substance from brewer 12. Wash pump 28 supplies water to brewer 12 for clearing the used brewing substance out of brewer 12. A flowmeter 25 tracks the amount of water supplied to brewer 12 for forming the brewed beverage. A pressure valve 27 allows water to feed back into tank 22 from in-line heaters 26 when the pressure is above a threshold value. A spray-head valve 29 selectively allows water to flow through an upper portion of brewer 12.

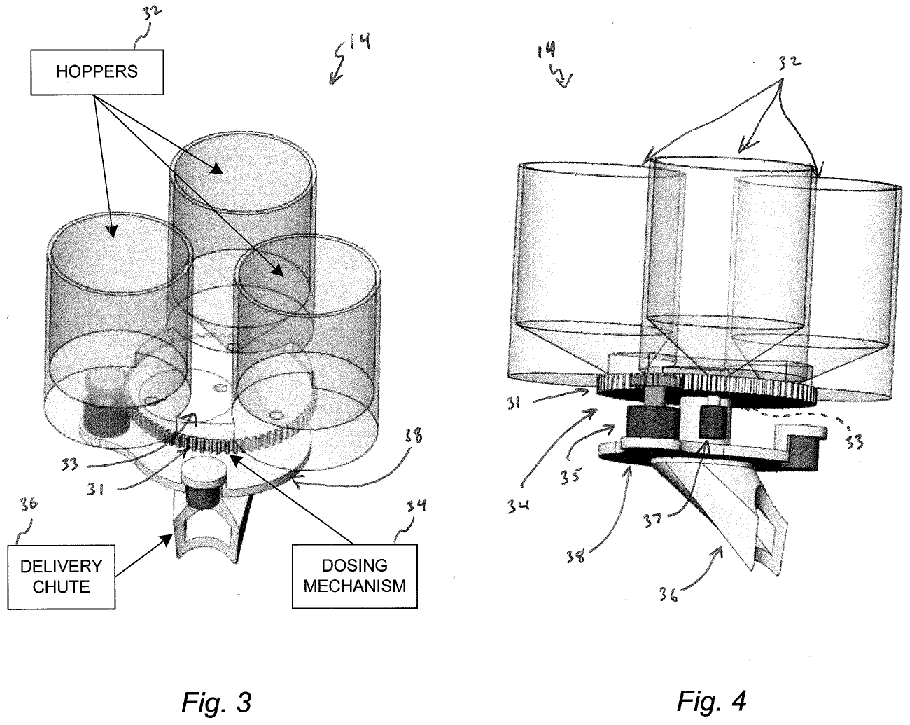

Brewing-substance delivery system 14 includes hoppers 32, a dosing mechanism 34, and a delivery chute 36 each coupled to a support plate 38 as shown in FIG. 3. Hoppers store various types of brewing substances, such as pre-ground tea or coffee, used for brewing various beverages at the selection of a user. Dosing mechanism 34 is adjustable to deliver brewing substance from one of hoppers 32 containing the brewing substance used for the selected brew cycle through chute 36 into brewer 12. Dosing mechanism 34 includes an index plate 31 and a feed plate 33 coupled to index plate 31 for movement therewith as suggested in FIGS. 3 and 4. A motor 35 rotates index plate 31 relative to support plate 38 to position feed plate 33 relative to a selected hopper 32, and a motor 37 rotates feed plate 33 relative to index plate 31 to pass brewing substance from hopper 32 into chute 36.

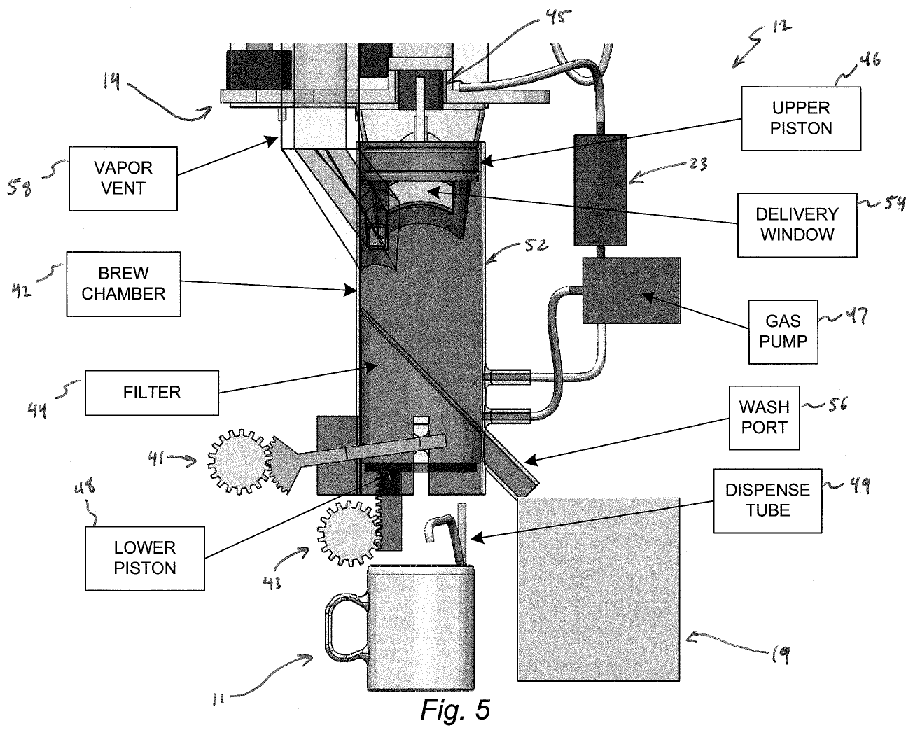

Brewer 12 includes a brew chamber 42, a filter 44, an upper piston 46, and a lower piston 48 as shown in FIG. 5. Brew chamber 42 includes a cylindrical side wall 52 having open upper and lower ends, a delivery window 54 formed through side wall 52 adjacent the upper end, and a wash port 56 coupled to side wall 52 adjacent the lower end. Upper piston 46 closes the upper end of brew chamber 42 and is selectively axially movable relative to brew chamber 42 using a motor 45. Filter 44 and lower piston 48 close the lower end of brew chamber 42 and are each selectively axially movable relative to brew chamber 42 using lifters 41, 43, respectively.

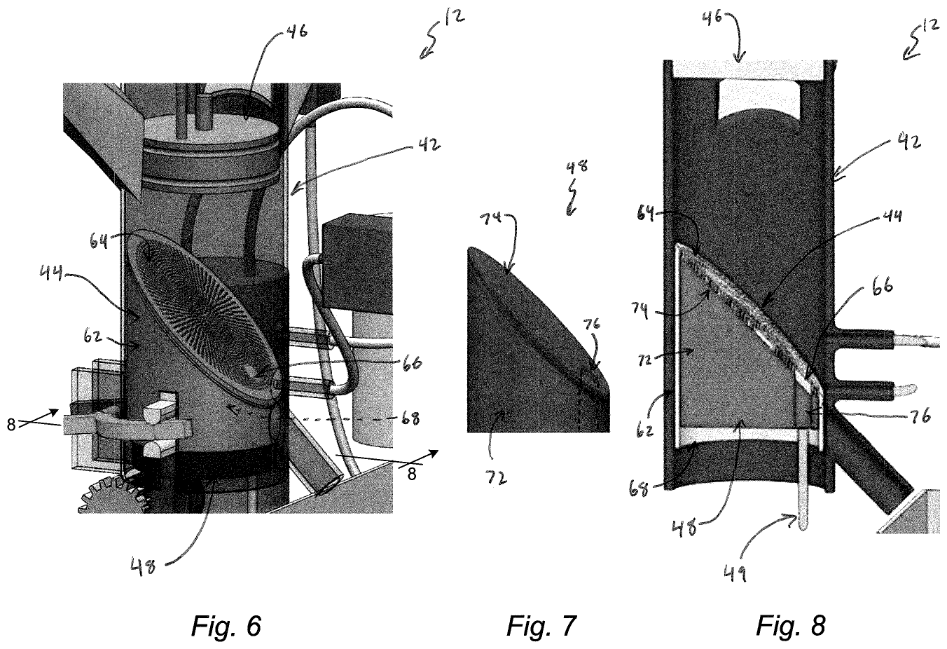

Filter 44 includes a cylindrical side wall 62 sized to be received in brew chamber 42, a slanted filter screen 64 coupled to side wall 62 to define an interior region 68 of filter 44, and a plug 66 coupled to filter screen 64 as shown in FIG. 6. Lower piston 48 includes a body 72, a slanted top 74, and a hole 76 (sometimes called a dispense port) extending through body 72 as shown in FIG. 7. Lower piston 48 is sized to be received in filter 44 as shown in FIG. 8. Top wall 74 engages with filter screen 64 and plug 66 engages with hole 76 to block liquid from passing out of the lower end of brew chamber 42 when lower piston 48 is in a closed position. Lower piston 48 is movable relative to an open position relative to filter 44 where top wall is spaced apart from filter screen 64 and plug 66 is spaced apart from hole 76 to allow brewed beverage to pass through filter screen 64 and hole 76 to a dispense tube 49 for dispensing the brewed beverage to container 11.

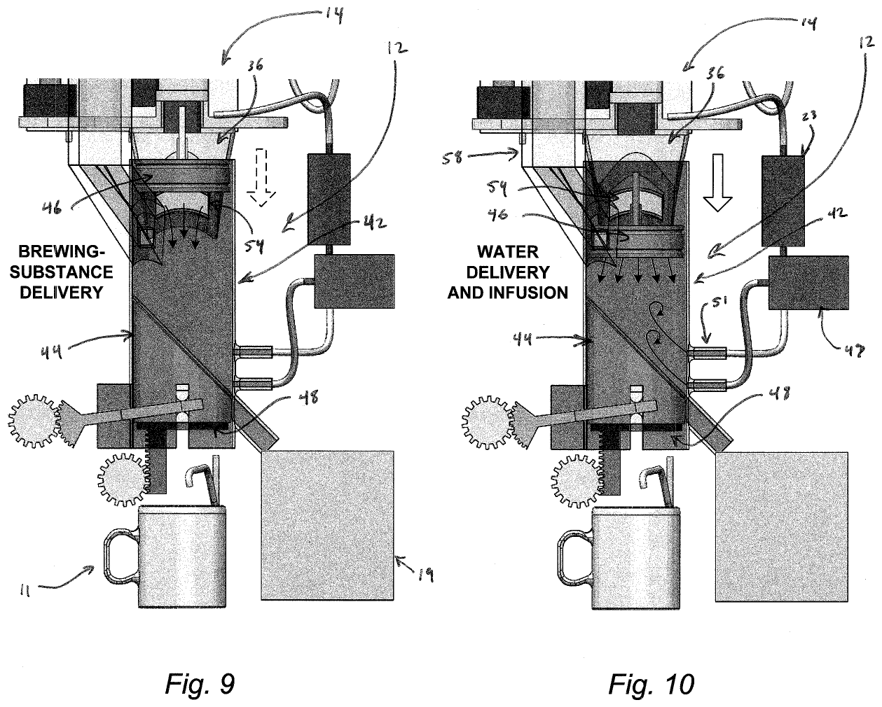

In one illustrative embodiment of a brew cycle of automatic brewing system 10, brewing substance is delivered by brewing-substance delivery system 14 into brew chamber 42 through delivery window 54, and the upper piston 46 moves to close delivery window 54 to block moisture from entering brewing-substance delivery system 14 as suggested in FIGS. 9 and 10. Upper piston 46 also closes a vapor vent 58 to seal brew chamber 42. Heated water is supplied through a spray head of upper piston 46 and/or through an injection port 51 into brew chamber 42 for mixing with the brewing substance as suggested in FIG. 10. A gas pump 47 provides a pressurized gas, such as air or nitrogen, into brew chamber 42 to circulate the brewing system through the water and aid formation of the brewed beverage.

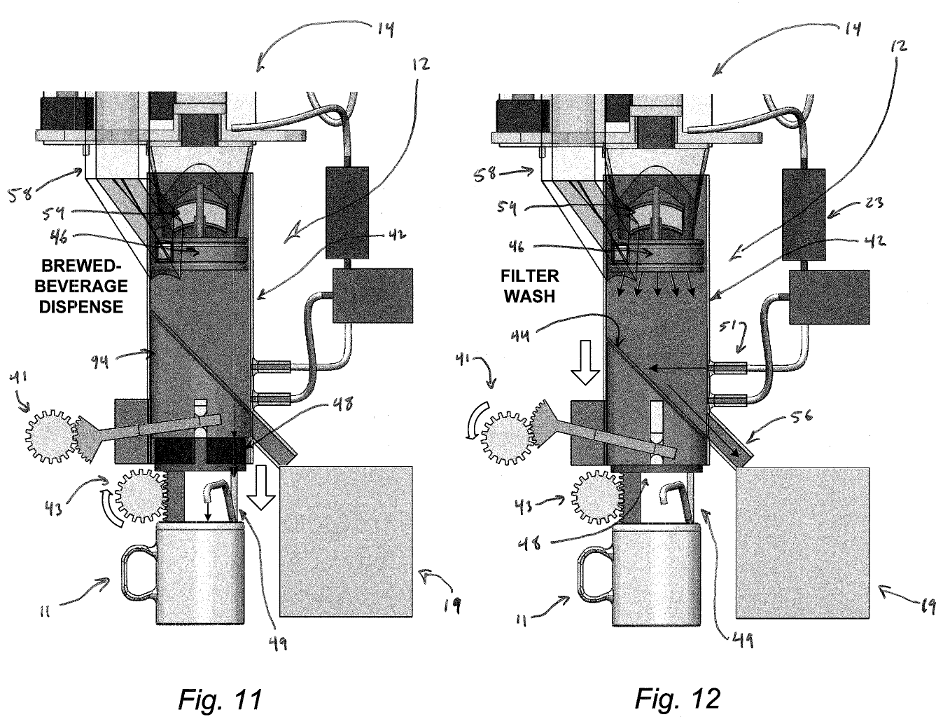

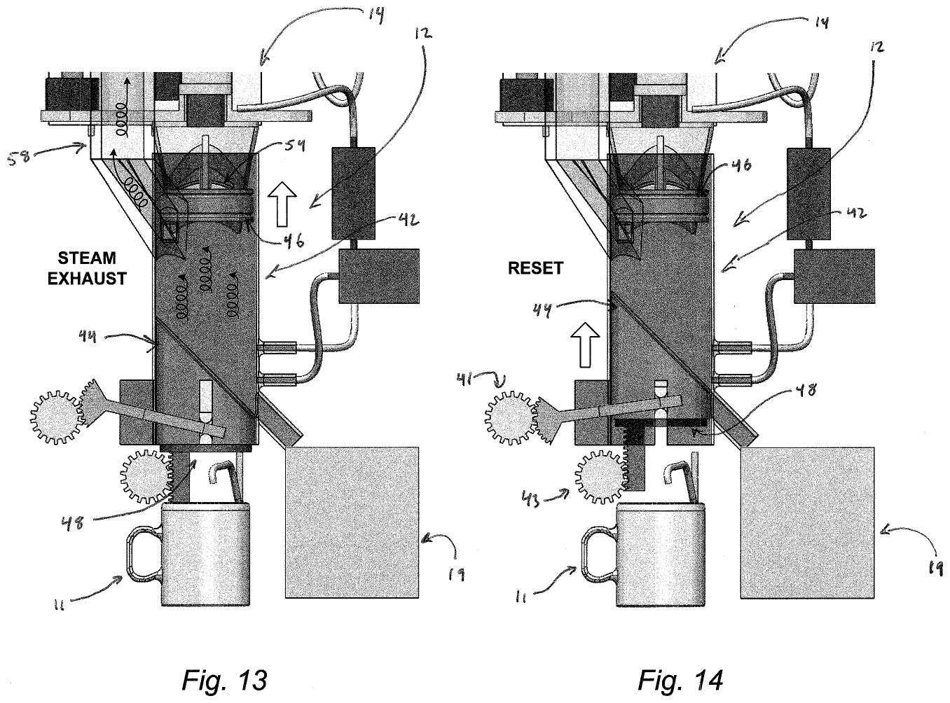

Lower piston 48 is moved to the opened position by lifter 43 to dispense the brewed beverage into container 11 as suggested in FIG. 11. Filter 44 is lowered by lifter 41 to expose wash port 56, and water is supplied through the spray head of upper piston 46 and/or through injection port 51 into brew chamber 42 for clearing used brewing substance off of filter 44 and out of brew chamber 42 as suggested in FIG. 12. Filter 44 engages with lower piston 48 during the wash phase to block wash water from passing through dispense tube 49. Upper piston 46 is raised to expose vapor vent 58 and allow residual steam to pass out of brew chamber 42 as suggested in FIG. 13. Filter 44 and lower piston 48 are raised to the closed position to reset automatic brewing system 10 for another brew cycle as suggested in FIG. 14. Upper piston 46 is raised to expose delivery window 54 at the start of the next brew cycle to allow brewing substance to enter brew chamber 42.

In illustrative embodiments, a controller is used to operate automatic brewing system 10 and can include a user interface for selecting various aspects of the brew process, such as the type of brewing substance, the strength of the brewed beverage, the amount of brewed beverage, and other parameters.

While the present disclosure describes various exemplary embodiments, the disclosure is not so limited. To the contrary, the disclosure is intended to cover various modifications, uses, adaptations, and equivalent arrangements based on the principles disclosed. Further, this application is intended to cover such departures from the present disclosure as come within at least the known or customary practice within the art to which it pertains. It is envisioned that those skilled in the art may devise various modifications and equivalent structures and functions without departing from the spirit and scope of the disclosure as recited in the following claims. The scope of the following claims is to be accorded the broadest interpretation to encompass all such modifications and equivalent structures and functions.

1. An automatic brewing system comprising:
a brewer having a brew chamber, a filter forming a bottom of the brew chamber, and a wash port formed in a side of the brew chamber adjacent to the filter, at least a portion of the filter being sloped relative to the brew chamber for directing liquid toward the wash port;
a brewing-substance delivery system coupled to the brewer, the brewing-substance delivery system configured to deliver a brewing substance into the brew chamber on the filter; and
a water-delivery system coupled to the brewer, the water-delivery system configured to controllably deliver water into the brew chamber for combination with the brewing substance to form a brewed beverage during at least a first portion of a brew cycle,
wherein a dispense port is configured to controllably dispense the brewed beverage from the brew chamber through the filter and separate from the brewing substance, the wash port and the dispense port are closed during at least the first portion of the brew cycle when the brewed beverage is formed, the wash port is controllably maintained closed and the dispense port is controllably opened during at least a second portion of the brew cycle to controllably pass the brewed beverage from the brew chamber, and the wash port is controllably opened and the dispense port is controllably closed to facilitate flushing the brewing substance from the filter and out of the brew chamber through the wash port during at least a third portion of the brew cycle.

2. The automatic brewing system of claim 1, further comprising a lower piston coupled to the brew chamber and movable relative to the filter, wherein the dispense port is formed through the lower piston, and wherein movement of the lower piston opens and closes the dispense port.

3. The automatic brewing system of claim 2, wherein the filter is movable within the brew chamber, and wherein movement of the filter opens and closes the wash port.

4. The automatic brewing system of claim 3, further comprising an upper piston, wherein the brewing substance is delivered into the brew chamber through a delivery window, and wherein the upper piston closes the delivery window to block moisture from entering the brewing-substance delivery system during at least the first portion of the brew cycle.

5. The automatic brewing system of claim 4, wherein the brewing-substance delivery system includes at least one hopper, a controllable dosing mechanism, and a delivery chute, wherein the hopper stores brewing substance used for brewing beverage, and wherein the dosing mechanism is adjustable to deliver the brewing substance from the hopper through the delivery chute into the brew chamber.

6. The automatic brewing system of claim 17, wherein the dosing mechanism includes an index plate and a feed plate coupled to the index plate for movement therewith, wherein the index plate rotates to position the feed plate relative to a selected hopper, and wherein the feed plate passes brewing substance from the selected hopper into the delivery chute.

7. A brewer for forming a brewed beverage from a brewing substance and water, the brewer comprising:
a brew chamber;
a filter forming a bottom of the brew chamber; and
a wash port formed in a side of the brew chamber adjacent to the filter,
wherein a dispense port is configured to controllably dispense the brewed beverage from the brew chamber through the filter and separate from the brewing substance, at least a portion of the filter is sloped relative to the brew chamber for directing liquid toward the wash port, the wash port and the dispense port are closed during at least a first portion of the brew cycle when the brewed beverage is formed, the wash port is controllably maintained closed and the dispense port is controllably opened during at least a second portion of the brew cycle to controllably pass the brewed beverage from the brew chamber, and the wash port is controllably opened and the dispense port is controllably closed to facilitate flushing the brewing substance from the filter and out of the brew chamber through the wash port during at least a third portion of the brew cycle.

8. The brewer of claim 7, further comprising a lower piston coupled to the brew chamber and movable relative to the filter, wherein the dispense port is formed through the lower piston, and wherein movement of the lower piston opens and closes the dispense port.

9. The brewer of claim 8, wherein the filter is movable within the brew chamber, and wherein movement of the filter opens and closes the wash port.

10. The brewer of claim 9, further comprising an upper piston, wherein the brewing substance is delivered into the brew chamber through a delivery window, and wherein the upper piston is controllably movable relative to the delivery window to block moisture from passing through the delivery window during at least the first portion of the brew cycle.

11. A method of operating a brewing system, the method comprising:
providing a brew chamber;
delivering a brewing substance onto a filter forming a bottom of the brew chamber, a wash port formed in a side of the brew chamber adjacent to the filter, at least a portion of the filter being sloped relative to the brew chamber for directing liquid toward the wash port;
delivering water into the brew chamber for combination with the brewing substance to form a brewed beverage during at least a first portion of a brew cycle, the wash port and a dispense port being closed during at least the first portion of the brew cycle;
dispensing the brewed beverage from the brew chamber through the filter to separate from the brewing substance and through the dispense port while the wash port is controllably maintained closed during at least a second portion of the brew cycle; and
closing the dispense port and flushing the brewing substance from the filter and out of the brew chamber through the wash port during at least a third portion of the brew cycle.

12. The method of claim 11, wherein a lower piston is positioned within the brew chamber and movable relative to the filter, wherein the dispense port is formed through the lower piston, and wherein movement of the lower piston opens and closes the dispense port.

13. The method of claim 12, wherein the filter is movable within the brew chamber, and wherein movement of the filter opens and closes the wash port.

14. The method of claim 13, wherein an upper piston is positioned in the brew chamber, wherein the brewing substance is delivered into the brew chamber through a delivery window, and wherein the upper piston is controllably displaced to close the delivery window during at least the first portion of the brew cycle.

15. The method of claim 14, wherein the brewing-substance delivery system includes at least one hopper, a controllable dosing mechanism, and a delivery chute, wherein the hopper stores brewing substances used for brewing beverage, and wherein the dosing mechanism is adjustable to deliver the brewing substance from the hopper through the delivery chute into the brew chamber.

16. The method of claim 18 wherein the dosing mechanism includes an index plate and a feed plate coupled to the index plate for movement therewith, wherein the index plate rotates to position the feed plate relative to a selected hopper, and wherein the feed plate passes brewing substance from the selected hopper into the delivery chute.

17. The automatic brewing system of claim 5, wherein the brewing-substance delivery system includes multiple hoppers communicating with the controllable dosing mechanism and delivery chute, wherein the hoppers store various types of brewing substances used for brewing various beverages at the selection of a user, and wherein the dosing mechanism is adjustable to deliver the various brewing substances from the hoppers through the delivery chute into the brew chamber.

18. The method of claim 15, wherein the brewing-substance delivery system includes multiple hoppers communicating with the controllable dosing mechanism and delivery chute, wherein the hoppers store various types of brewing substances used for brewing various beverages at the selection of a user, and wherein the dosing mechanism is adjustable to deliver the various brewing substances from the hoppers through the delivery chute into the brew chamber.
